(19) United States
(12) Patent Application Publication
(10) Pub. No.: US 2026/0121317 A1
(43) Pub. Date: Apr. 30, 2026

(54) CONNECTOR AND CONNECTOR PAIR

(71) Applicant: Molex, LLC, Lisle, IL (US)

(72) Inventors: Kai Murakami, Yamato (JP); Kimiyasu Makino, Yamato (JP); Hidehoro Matsushita, Yamato (JP)

(21) Appl. No.: 19/352,654

(22) Filed: Oct. 8, 2025

(30) Foreign Application Priority Data
Oct. 29, 2024 (JP) 2024-189758

(51) Int. Cl. H01R 12/71; H01R 13/6585

(52) U.S. Cl. CPC H01R 12/716; H01R 13/6585

(57) ABSTRACT

A housing; and a terminal unit retained in the housing; wherein the terminal unit includes a signal terminal, a shield terminal surrounding the signal terminal, and a terminal housing to which the signal terminal and the shield terminal are mounted,

the terminal housing includes a crush rib protruding outward from the shield terminal, and

the housing is formed with a terminal unit stowing cavity in which the terminal unit is stowed, the terminal unit being stowed and retained in the terminal unit stowing cavity with the shield terminal not in contact with the housing.

### TECHNICAL FIELD

The present disclosure relates to a connector and a connector pair.

### BACKGROUND

Conventionally, connectors with a large number of terminals arranged in a so-called pin grid array have been used to connect semiconductor devices to circuit boards or to connect boards to each other and transmit high-speed signals (see, for example, Patent Document 1).

FIG. 23 is a perspective view depicting a conventional connector.

In the figure, reference numeral 811 denotes a connector housing, which is integrally formed from an insulating material such as synthetic resin and has a roughly rectangular thick plate-shape. In the housing 811, on the side where the counterpart connector (not depicted) is inserted, in other words, the mating surface side (upper side in FIG. 23), a plurality of protruding walls 813 are arranged in parallel and are formed to protrude from the bottom surface toward the mating surface side, extending in the longitudinal direction of the housing 811. In addition, there is a groove-shaped slot 812 extending in the longitudinal direction of the housing 811 between adjacent protruding walls 813, and when mating with the counterpart connector, a protruding wall formed on the counterpart connector housing is inserted therein.

Each protruding wall 813 has a ground terminal row 850 formed on a first side thereof and a hybrid terminal row 860 formed on a second side thereof. In the ground terminal row 850, a plurality of pairs of ground terminals 851 are arranged so that the intervals between adjacent pairs are wide. On the other hand, in the hybrid terminal row 860, a plurality of pairs of differential signal terminals 861 are arranged so that the spacing between adjacent pairs is wide, and one ground terminal 851 is arranged between pairs of differential signal terminals 861. In each protruding wall 813, a pair of ground terminals 851 in the ground terminal row 850 and a pair of differential signal terminals 861 in the hybrid terminal row 860 are positioned so that they are back to back, and in each slot 812, a pair of ground terminals 851 in the ground terminal row 850 and a pair of differential signal terminals 861 in the hybrid terminal row 860 are positioned so as to face each other.

As a result, the ground terminals 851 are arranged on the front, rear, left and right sides of each pair of differential signal terminals 861, thereby suppressing crosstalk between pairs of differential signal terminals 861.

Prior Art Documents: Patent Document 1: Japanese Unexamined Patent Application Publication 2022-108725

### SUMMARY

However, with the conventional connector, although the ground terminals 851 are arranged on the front, rear, left and right sides of each pair of differential signal terminals 861, the ground terminals 851 are spaced apart from each other, so a sufficient shielding effect cannot be obtained, and if the transmitted signals are high-speed (for example, at a speed of 224 Gbps or more), crosstalk cannot be sufficiently suppressed.

In addition, in the differential signal terminal 861 of the conventional connector, the point of contact with the differential signal terminal of the counterpart connector is located further toward the base end than the tip end, so a stub is formed in the signal transmission path, making the impedance unstable and rendering the configuration unsuitable for high-speed signal transmission.

Furthermore, in recent years, as electronic devices and the like have become smaller and thinner, the connectors that are mounted inside the cases of such electronic devices have also become smaller and thinner, but conventional connectors cannot easily accommodate this trend toward smaller size and lower height.

Furthermore, in recent years, connectors used for high-speed signal transmission have become increasingly multipolar. However, the ground terminal 851 and differential signal terminal 861 of a conventional connector have a large frictional resistance when they come into contact with the ground terminal and differential signal terminal of the counterpart connector, and therefore, when the connector is made multipolar, the mating force required to mate with the counterpart connector becomes too large. Furthermore, no measures are taken to protect the ground terminal 851 and the differential signal terminal 861 from the force acting in a direction orthogonal to the mating direction (the width direction of the housing 811) upon coming into contact with the ground terminal and the differential signal terminal of the counterpart connector, making the mating operation difficult.

An objective is to solve the above-mentioned conventional problems and provide a connector and connector pair that can stably maintain the contact state of the terminals, are suitable for transmitting high-speed signals, are capable of multi-polarization, have a simple structure, are low cost, are easy to mate, and are small, low-profile, and highly reliable.

Therefore, a connector includes:

a housing; and a terminal unit retained in the housing; wherein the terminal unit includes a signal terminal, a shield terminal surrounding the signal terminal, and a terminal housing to which the signal terminal and the shield terminal are mounted,
the terminal housing includes a crush rib protruding outward from the shield terminal, and
the housing is formed with a terminal unit stowing cavity in which the terminal unit is stowed, the terminal unit being stowed and retained in the terminal unit stowing cavity with the shield terminal not in contact with the housing.

With another connector, the terminal unit stowing cavity includes a terminal unit retention opening penetrating a lower surface of the housing, and the crush rib abuts against an inner wall surface of the terminal unit retention opening.

In yet another connector, the signal terminal includes a board connection part formed at a lower end thereof, the shield terminal includes a board connection part formed at a lower end thereof, and the board connection parts of the signal terminal and the shield terminal are exposed on a lower surface of the housing.

In yet another connector, the shield terminal includes a U-shaped terminal having a main body part and a pair of side plate parts extending from both ends of the main body part, and the crush rib includes a rear protruding part protruding rearward from an outer surface of the main body part, a sideward protruding part protruding outward in a width direction from an outer surface of the side plate part, and a forward protruding part protruding forward from a front end of the side plate part.

In yet another connector, there are a plurality of terminal unit stowing cavities, arranged so as to form a plurality of pairs of rows extending in a width direction of the housing, and, in each pair, a terminal unit stowed in a terminal unit stowing cavity forming a first row and a terminal unit stowed in a terminal unit stowing cavity forming a second row face each other.

In yet another connector, a plurality of terminal unit stowing cavities are provided, and are arranged so as to form a plurality of rows extending in a longitudinal direction of the housing, and terminal units stowed in terminal unit stowing cavities located on opposite sides from a widthwise center of the housing face in opposite directions to each other.

The connector pair includes a connector according to the present disclosure and a counterpart connector that mates with the connector.

According to the present disclosure, the connector and connector pair can stably maintain the contact state of the terminals, are suitable for transmitting high-speed signals, can be made multi-polar, can have a simplified structure, can reduce costs, can be easily mated, can be made smaller and thinner, and have improved reliability.

### BRIEF DESCRIPTION OF THE DRAWINGS

FIG. 1 is a perspective view from the mating surface side of a connector according to Embodiment 1;

FIG. 2 is an enlarged view of a main part of the connector in Embodiment 1, and is an enlarged view of the A part in FIG. 1;

FIG. 3 is a perspective view from the mounting surface side of a connector according to Embodiment 1;

FIG. 4 is a perspective view depicting the state in which the connector and the counterpart connector according to Embodiment 1 are mated, as viewed from the counterpart connector;

FIGS. 5A-C are a three-view drawing of the first connector according to Embodiment 1, wherein FIG. 5A is a plan view, FIG. 5B is a sectional view taken along the B-B line in FIG. 5A, and FIG. 5C is a sectional view taken along the C-C line in FIG. 5A;

FIG. 6 is a first perspective view of the terminal unit according to Embodiment 1;

FIGS. 7A-B are a first exploded view of the terminal unit in FIG. 6, in which FIG. 7A depicts a tab-shaped terminal and FIG. 7B depicts a signal terminal;

FIGS. 8A-B are a second exploded view of the terminal unit in FIG. 6, in which FIG. 8A depicts a terminal housing and FIG. 8B depicts a U-shaped terminal;

FIG. 9 is a third exploded view of the terminal unit in FIG. 6, depicting a state in which the signal terminals are retained in the terminal housing;

FIG. 10 is a second perspective view of the terminal unit according to Embodiment 1;

FIGS. 11A-B are a first exploded view of the terminal unit in FIG. 10, in which FIG. 11A depicts a tab-shaped terminal and FIG. 11B depicts a signal terminal;

FIGS. 12A-B are a second exploded view of the terminal unit in FIG. 10, in which FIG. 12A depicts a terminal housing and FIG. 12B depicts a U-shaped terminal;

FIG. 13 is a third exploded view of the terminal unit of FIG. 10, depicting the signal terminals retained in the terminal housing;

FIG. 14 is a third perspective view of the terminal unit according to Embodiment 1;

FIGS. 15A-B are a first two-view drawing of the terminal unit according to Embodiment 1, in which FIG. 15A is a front view and FIG. 15B is a right-side view;

FIGS. 16A-B are a second two-view drawing of the terminal unit according to Embodiment 1, in which FIG. 16A is a rear view and FIG. 16B is a left-side view;

FIGS. 17A-B are a third two-view drawing of the terminal unit according to Embodiment 1, in which FIG. 17A is a bottom view and FIG. 17B is a plan view;

FIGS. 18A-C are a three-view drawing depicting a state in which terminal units of Embodiment 1 are connected to each other, in which FIG. 18A is a plan view, FIG. 18B is a right-side view, and FIG. 18C is a rear view;

FIGS. 19A-B are a cross-sectional view depicting the state in which terminal units in Embodiment 1 are connected to each other, where FIG. 19A is a cross-sectional view along the line D-D in FIG. 18A, and FIG. 19B is a cross-sectional view taken along the line E-E in FIG. 18A;

FIG. 20 is a perspective view depicting a state immediately before the connector and the counterpart connector according to Embodiment 2 are mated;

FIG. 21 is an enlarged view of a main part of the connector according to Embodiment 2, and is an enlarged view of part F in FIG. 20;

FIGS. 22A-C are a three-view drawing depicting the state in which the connector and the counterpart connector in Embodiment 2 are mated, in which FIG. 22A is a plan view as viewed from the counterpart connector side, FIG. 22B is a cross-sectional view along the line G-G in FIG. 22A, and FIG. 22C is a cross-sectional view along the line H-H in FIG. 22A; and

FIG. 23 is a perspective view depicting a conventional connector.

### DETAILED DESCRIPTION

Embodiments will hereinafter be described in detail with reference to the drawings.

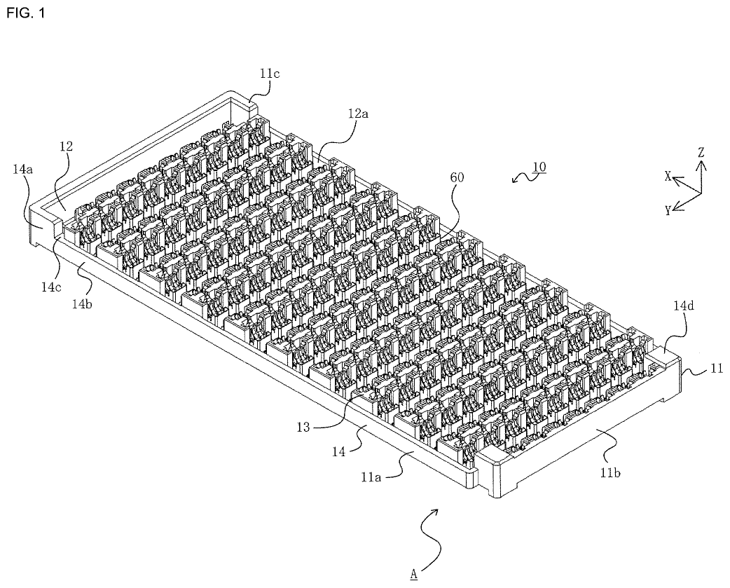

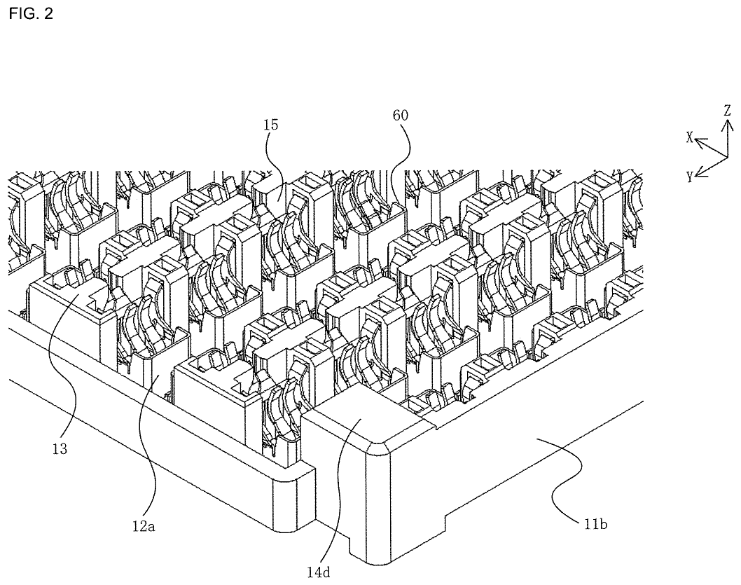

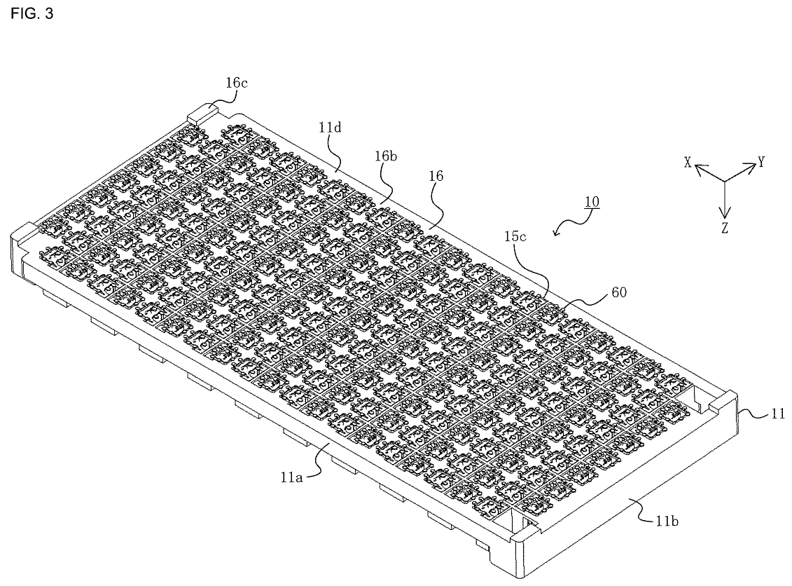

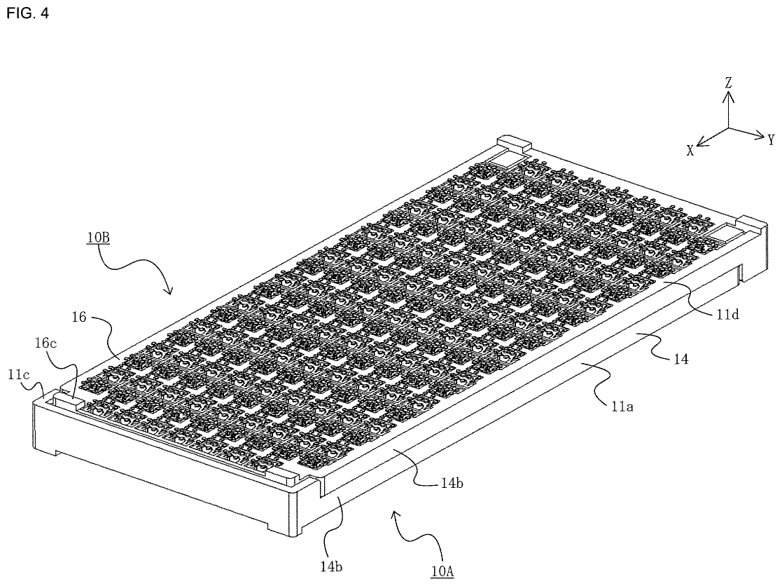

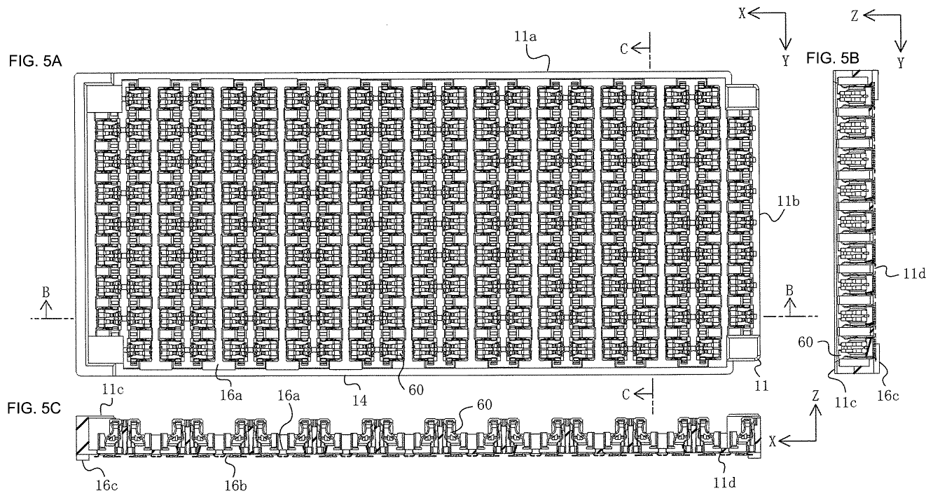

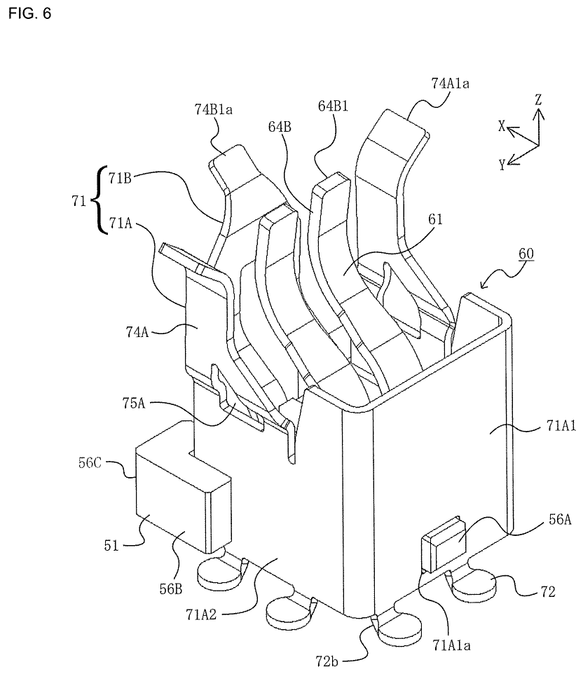

FIG. 1 is a perspective view from the mating surface side of a connector according to Embodiment 1. FIG. 2 is an enlarged view of a main part of the connector in Embodiment 1, and is an enlarged view of the A part in FIG. 1. FIG. 3 is a perspective view from the mounting surface side of a connector according to Embodiment 1. FIG. 4 is a perspective view depicting the state in which the connector and the counterpart connector according to Embodiment 1 are mated, as viewed from the counterpart connector. FIGS. 5A-C are a three-view drawing of the connector according to Embodiment 1. Note that FIG. 5A is a plan view, FIG. 5B is a cross-sectional view along the line B-B in FIG. 5A, and FIG. 5C is a cross-sectional view along the line C-C in FIG. 5A.

In the drawings, reference numeral 10 indicates a connector of the present embodiment, which is, as an example, one of a board-to-board connector, a pair of connectors used to connect boards together, and is described as a surface-mount connector mounted on the surface of a board such as a circuit board (not depicted), and also as a so-called pin grid array connector. Furthermore, the connector 10 in the present embodiment is a type of so-called hermaphroditic connector, and as depicted in FIG. 4, the connector mates with another connector 10 of the same configuration to function as a pair of board-to-board connectors. Here, when identifying and describing each of the connectors 10 that make up a connector pair, a first will be referred to as connector 10A and a second as counterpart connector 10B, and when describing connector 10A and counterpart connector 10B collectively, they will be described as connector 10.

Note that the board may be, for example, a printed circuit board used in electronic devices, a flexible flat cable (FFC), a flexible printed circuit board (FPC), or the like, but may be any type of board.

In addition, in the present embodiment, the expressions indicating directions such as up, down, left, right, front, and rear used to explain the configuration and operation of each part of the connector 10 are relative rather than absolute, and are appropriate when each part of the connector 10 is in the orientation depicted in the figure, but if the orientation changes, they should be interpreted differently in accordance with the change in orientation.

The connector 10 has a connector housing 11 which is an integrally formed housing formed of an insulating material such as synthetic resin. As depicted in the figure, the connector housing 11 has a roughly rectangular thick plate-shape and has a pair of parallel long side parts 11a extending in the longitudinal direction of the connector 10, and a pair of parallel short side parts 11b extending in the width direction of the connector 10. In addition, on the side of the connector housing 11 that mates with the counterpart connector 10B, in other words, the mating surface 11c side (upper side in FIG. 1), a roughly rectangular recess part 12 is formed whose bottom surface is demarcated by an upper surface 16a of a bottom plate part 16 and whose periphery is surrounded by a side wall part 14, and a plurality of terminal units 60 are arranged therein.

Note that the connector 10 is a low-profile connector with a height dimension (Z-axis direction) of approximately 5 mm or less, and is suitable for ultra-high-speed signal transmission of 100 Gbps or more, for example, 224 Gbps, but is not necessarily limited to this. In addition, the vertical (X-axis direction) and horizontal (Y-axis direction) dimensions of the connector 10 vary depending on the number of terminal units 60 arranged, that is, the number of poles. In the example depicted in the figure, the connector 10 has 185 poles, but having fewer poles or more poles is possible, so the connector can be a multi-pole connector with hundreds or even thousands of poles, and the vertical and horizontal dimensions will vary depending on the number of poles.

A plurality of protruding ridge parts 13 are formed integrally with the connector housing 11 within the recess part 12. In this case, the protruding ridge part 13 protrudes upward from the upper surface 16a of the bottom plate part 16 and extends in the width direction of the connector housing 11. As a result, on both sides of the protruding ridge part 13, a long and narrow groove part 12a extending in the width direction of the connector housing 11 is formed. Note that in the example depicted in the drawing, there are ten protruding ridge parts 13, but the number may be one or more, and any number may be used.

Here, terminal unit stowing cavities 15 are formed on both side walls of the protruding ridge parts 13 as terminal stowing cavities for stowing the terminal units 60. A plurality of the terminal unit stowing cavities 15 are formed on both side walls of each of the protruding ridge parts 13 at a pitch of, for example, about 1 mm. Each of the terminal unit stowing cavities 15 stows one terminal unit 60. Note that the pitch and number of the terminal unit stowing cavities 15 and the terminal units 60 can be set as appropriate.

The terminal unit 60 of the connector 10A and the terminal unit 60 of the counterpart connector 10B have the same configuration, but when distinguishing and describing each, the terminal unit 60 of the connector 10A will be referred to as terminal unit 60A, and the terminal unit 60 of the counterpart connector 10B will be referred to as counterpart terminal unit 60B. As depicted in FIG. 4, when the connector 10A and the counterpart connector 10B are mated, each of the terminal units 60A is connected to the corresponding counterpart terminal units 60B.

As depicted in FIG. 1, the side wall part 14 includes a relatively high wall part 14a and a low wall part 14b that is lower in height than the high wall part 14a. The high wall part 14a extends over the entire length of the short side part 11b at a first longitudinal end of the connector housing 11, and extends from both ends of the short side part 11b along the long side part 11a for a prescribed length toward a second short side part 11b. The low wall part 14b extends over most of the long side part 11a, and there is a notched part 14c above the low wall part 14b, which is formed by removing a portion of the high wall part 14a near the upper end. As depicted in FIG. 4, the notched part 14c is a portion into which the low wall part 14b of the counterpart connector 10B fits when the connector 10A is mated with the counterpart connector 10B. In addition, at both ends of the short side part 11b at the second longitudinal end of the connector housing 11, there are formed protruding wall parts 14d that protrude upward. As depicted in FIG. 4, when the connector 10A is mated with the counterpart connector 10B, the protruding wall part 14d is the portion inserted into the recess part 12 near the short side part 11b of the counterpart connector 10B.

As depicted in FIG. 3, a lower surface 16b of the bottom plate part 16 of the connector housing 11 is provided with housing legs 16c that project downward, at a plurality of locations on the periphery thereof. The housing legs 16c have their lower surfaces in contact with the surface of the board, thereby functioning as spacers that maintain a prescribed distance between the surface of the board and the mounting surface 11d, which is the lower surface of the connector housing 11.

In addition, the terminal unit stowing cavities 15 are formed so as to communicate from the upper surface of the protruding ridge parts 13 to the lower surface 16b of the bottom plate part 16, and a terminal unit retention opening 15c, which is a through hole that penetrates the lower surface 16b in the vertical direction, is formed on the lower surface 16b of the bottom plate part 16. The portion near the lower end of each terminal unit 60 is stowed and retained within each terminal unit retention opening 15c, and the tail parts 62 and 72 (described below) of each terminal unit 60 are exposed on the lower surface 16b of the bottom plate part 16. The tail parts 62 and 72 are so-called solder tails, and are connected by soldering or the like to terminal connection pads that are connected to conductive traces on the board.

Next, the configuration of the terminal unit 60 will be described.

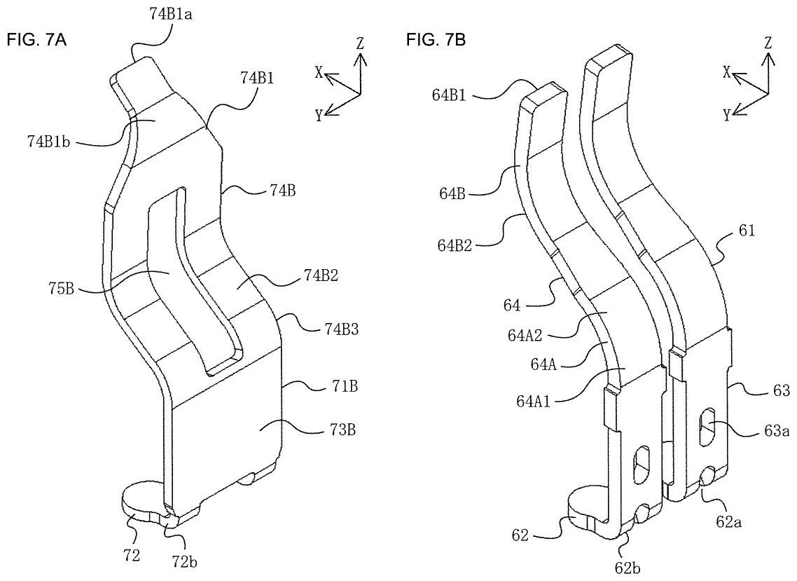

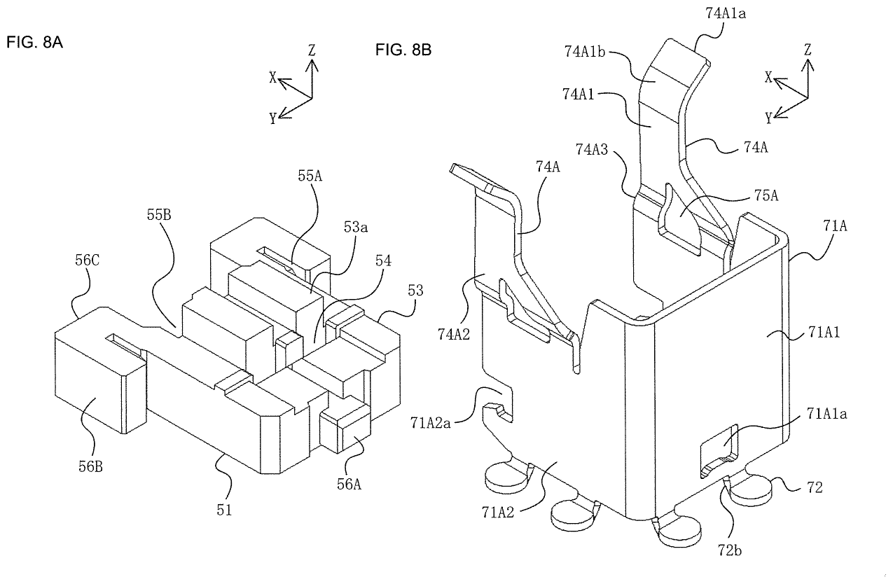

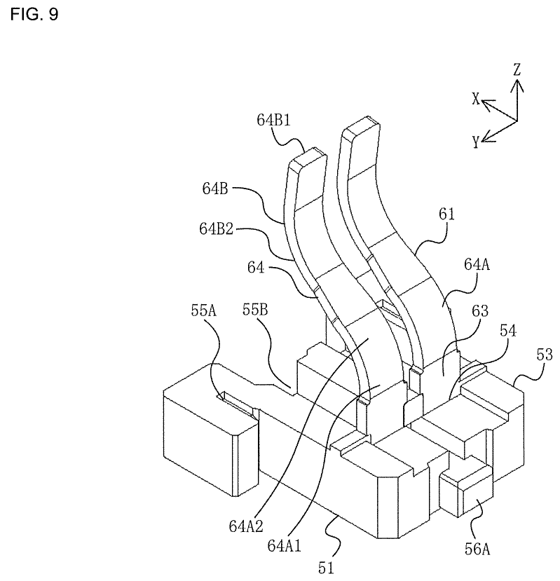

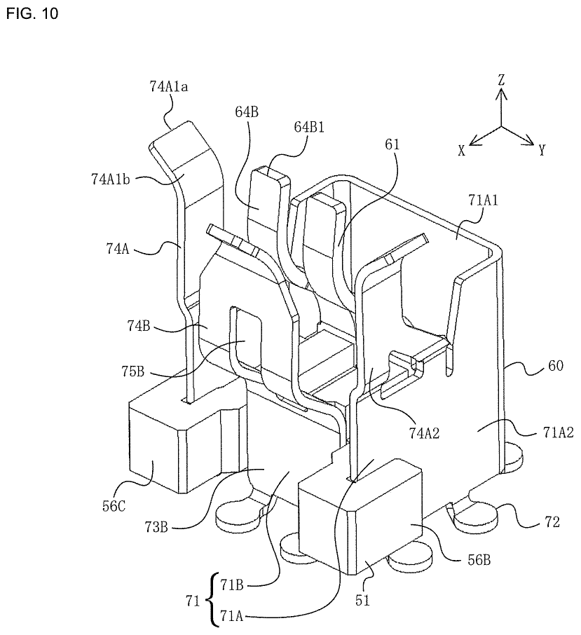

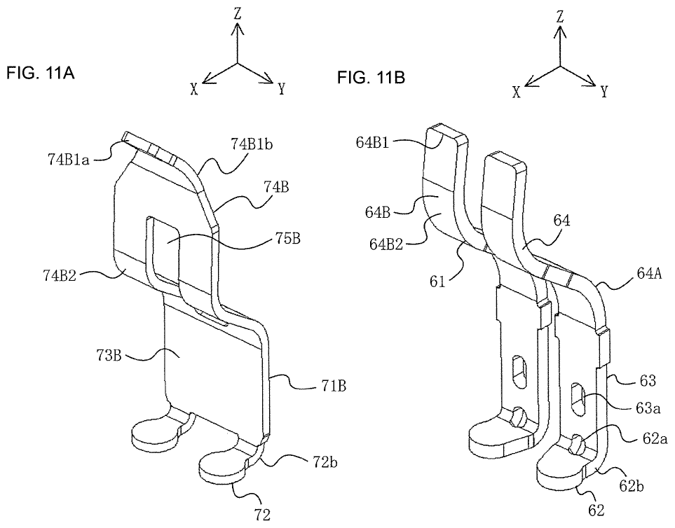

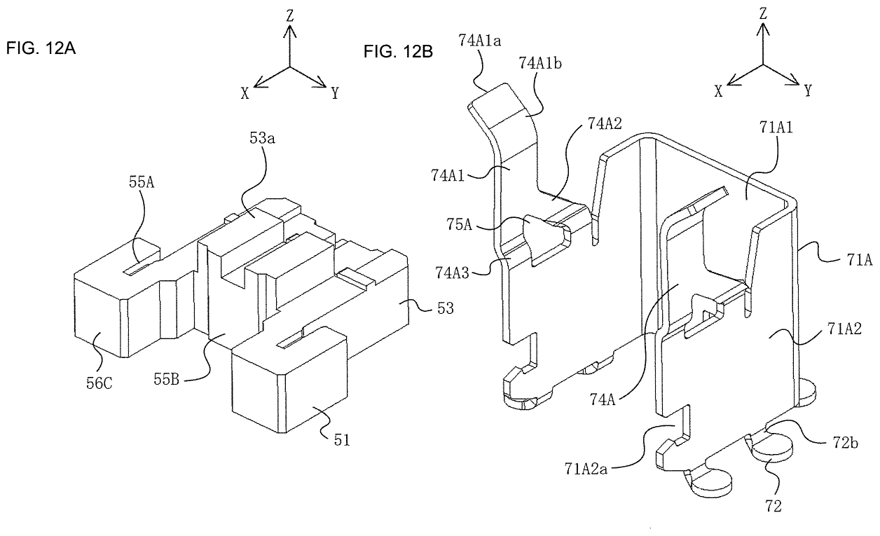

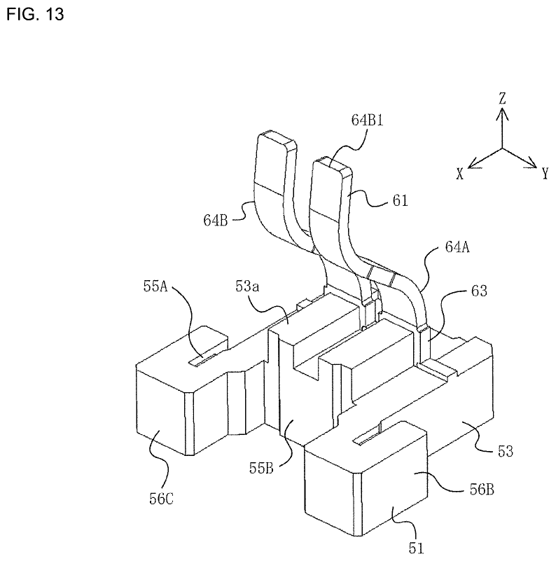

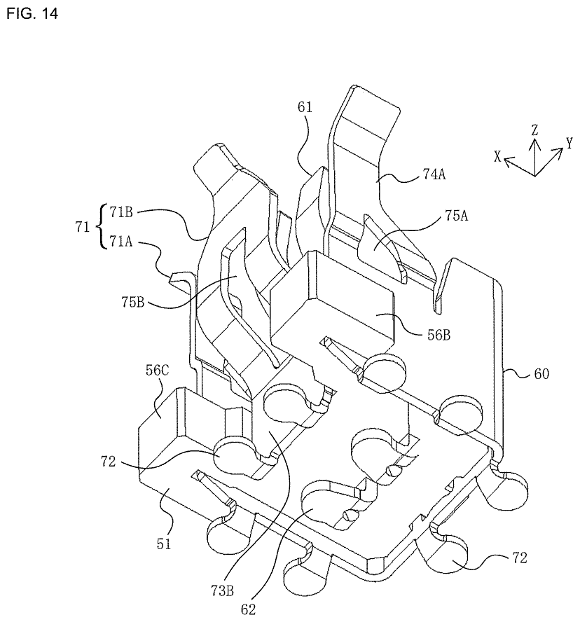

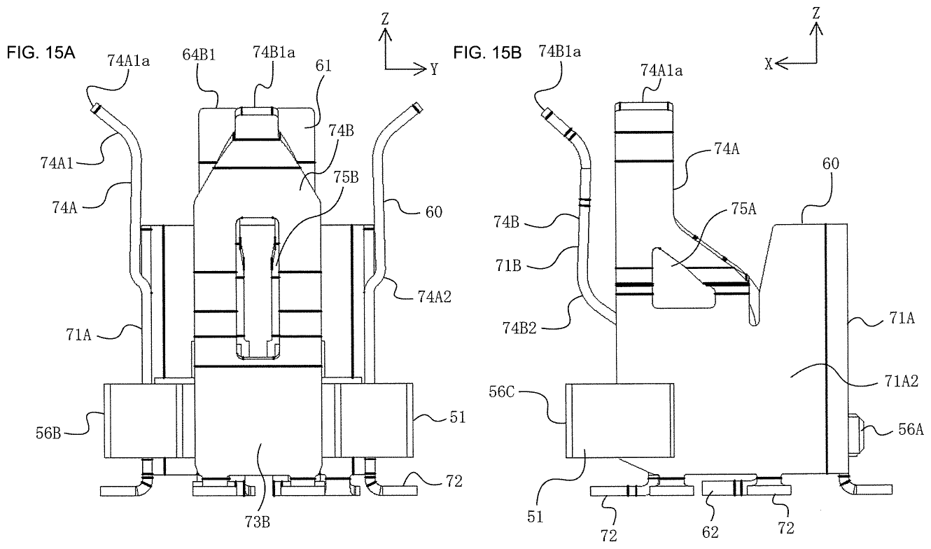

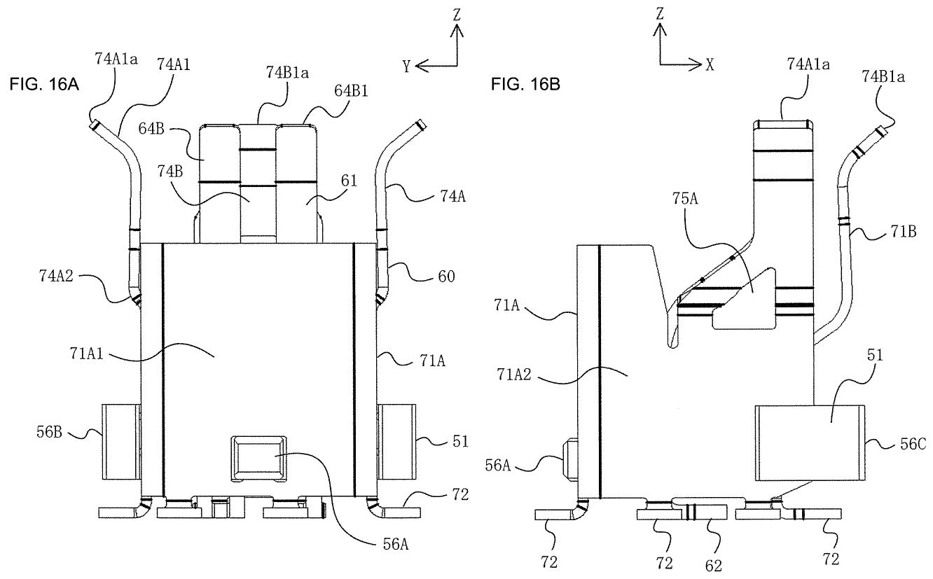

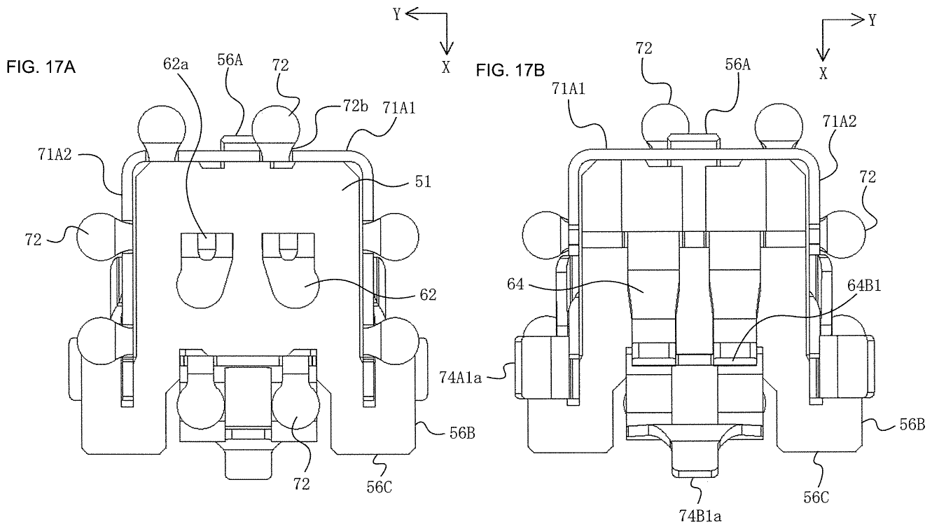

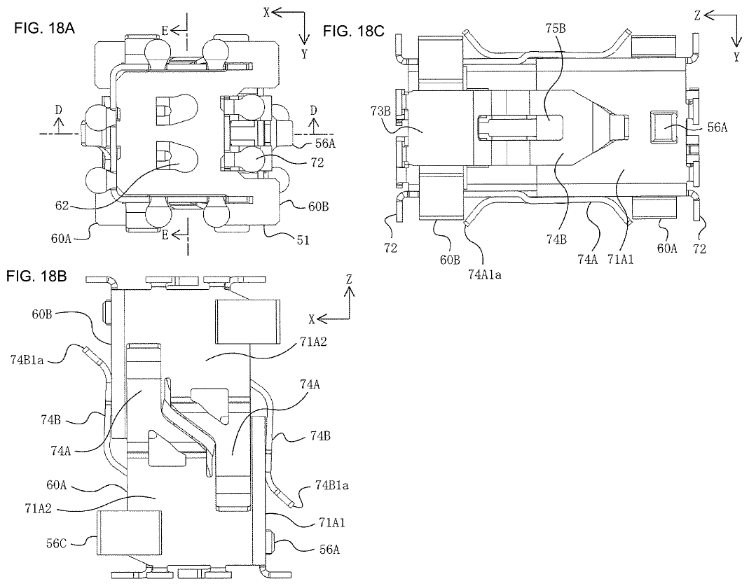

FIG. 6 is a first perspective view of the terminal unit according to Embodiment 1. FIGS. 7A-B are a first exploded view of the terminal unit in FIG. 6. FIGS. 8A-B are a second exploded view of the terminal unit in FIG. 6. FIG. 9 is a third exploded view of the terminal unit of FIG. 6, depicting the signal terminals retained in the terminal housing. FIG. 10 is a second perspective view of the terminal unit according to Embodiment 1. FIGS. 11A-B are a first exploded view of the terminal unit in FIG. 10. FIGS. 12A-B are a second exploded view of the terminal unit in FIG. 10. FIG. 13 is a third exploded view of the terminal unit of FIG. 10, depicting the signal terminals retained in the terminal housing. FIG. 14 is a third perspective view of the terminal unit according to Embodiment 1. FIGS. 15A-B are a first two-view drawing of the terminal unit according to Embodiment 1. FIGS. 16A-B are a second two-view drawing of the terminal unit according to Embodiment 1. FIGS. 17A-B are a third two-view drawing of the terminal unit according to Embodiment 1. Note that FIG. 7, Ais a view depicting the tab-shaped terminal, and FIG. 7B is a view depicting the signal terminal. In FIG. 8A is a view depicting the terminal housing, and FIG. 8B is a view depicting the U-shaped terminal. FIG. 11A is a view depicting the tab-shaped terminal, and FIG. 11B is a view depicting the signal terminal. FIG. 12A is a view depicting the terminal housing, and FIG. 12B is a view depicting the U-shaped terminal. In FIG. 15A is a front view, and FIG. 15B is a right-side view. In FIG. 16A is a rear view, and FIG. 16B is a left-side view. In FIG. 17A is a bottom view, and FIG. 17B is a plan view.

In the example depicted in the drawings, the terminal unit 60 includes a terminal housing 51 as a housing integrally formed from an insulating material such as synthetic resin, a signal terminal 61 as a terminal having elasticity formed by punching, bending, and the like from a conductive plate material such as a metal plate, and a shield terminal 71 as a shield member having elasticity formed by punching, bending, and the like from a conductive plate material such as a metal plate.

Note that the shield terminal 71 includes a U-shaped terminal 71A as a first shield terminal having a roughly U-shaped shape when viewed from above and below, and a tab-shaped terminal 71B as an elastically deformable second shield terminal having an overall shape roughly like a tab. Here, when the U-shaped terminal 71A and the tab-shaped terminal 71B are described collectively, they are described as the shield terminal 71, and when they are described individually, they are described as the U-shaped terminal 71A and the tab-shaped terminal 71B.

In addition, signal terminals 61 are a pair of members that are connected to the counterpart terminals, in other words, the signal terminals 61 of the counterpart terminal unit 60B, and are suitable for transmitting signals such as differential signals, and are arranged parallel to each other but spaced apart and facing the same direction as each other, as depicted in FIG. 7B and FIG. 11B, and are used while being retained by the terminal housing 51. Note that the signal terminal 61 has the same shape as the counterpart terminal, that is, the signal terminal 61 of the counterpart terminal unit 60B. In addition, the signal terminal 61 may be attached to the terminal housing 51 by means of press-fitting or the like, but for the sake of convenience, we will explain here the case where the signal terminal is integrated with the terminal housing 51 by overmolding or insert molding.

In this case, the terminal housing 51 is molded by filling an insulating material such as synthetic resin into the cavity of a mold in which at least a portion of the signal terminals 61 have been set beforehand, and as depicted in FIGS. 9 and 13, the terminal housing is integrally connected to a pair of signal terminals 61 at least at a part of the main body part 63 of the signal terminal 61. As depicted in FIG. 7B and FIG. 11B, a through hole 63a is preferably formed in the main body part 63, so that the insulating material is also filled into the through hole 63a, thereby strengthening the bond between the main body part 63 and the terminal housing 51. In addition, although the integrated terminal housing 51 and signal terminal 61 do not exist separately, for the sake of convenience of explanation, in FIGS. 7 and 8, and FIGS. 11 and 12, the terminal housing 51 and the signal terminal 61 are depicted as if they exist separately. A recess part 54 depicted in FIG. 8A is a portion in which the main body part 63 of the signal terminal 61 is stowed.

On the other hand, the U-shaped terminal 71A and the tab-shaped terminal 71B may be integrated with the terminal housing 51 by overmolding or insert molding, but here we will explain the case where they are attached to the terminal housing 51 by means of press-fitting or the like. In this case, the U-shaped terminal 71A is attached to the terminal housing 51 by pressing the engagement recess part 71A2a formed at the front end of a pair of side plate parts 71A2 and the vicinity thereof into a slit-shaped U-shaped terminal mounting recess part 55A formed in the terminal housing 51, and by pressing the rear protruding part 56A formed at the rear end of the terminal housing 51 into the engagement hole part 71A1a formed in the main body part 71A1. In addition, the tab-shaped terminal 71B is attached to the terminal housing 51 by press-fitting the main body part 73B into a tab-shaped terminal mounting recess part 55B formed on the front surface of the terminal housing 51.

As depicted in FIG. 7B and FIG. 11B, each of the signal terminals 61 includes a main body part 63 having an approximately rectangular plate-shape extending in the vertical direction (Z-axis direction), a tail part 62 connected to the lower end of the main body part 63 via a curved part 62b and serving as a board connection part extending forward (X-axis positive direction), and a contact part 64 connected to the upper end of the main body part 63 as a first contact part. The contact part 64 is a band-shaped member with a substantially constant width extending in the vertical direction, but when viewed from the side, in other words, in the width direction (Y-axis direction) of the terminal unit 60, the contact part is a member that is curved to form an approximately S-shape. Note that since the main body part 63 extends downward (Z-axis negative direction) from the lower end of the contact part 64, the signal terminal 61 as a whole can be said to have a generally S-shape in side view.

The contact part 64 includes a first contact part 64A located below and a second contact part 64B located above (Z-axis positive direction).

The second contact part 64B includes a free end 64B1 located at the tip end thereof and a gently curved second curved part 64B2. The free end 64B1 is the portion that comes into contact with the signal terminal 61 of the counterpart terminal unit 60B when the terminal unit 60A is connected to the counterpart terminal unit 60B. The tip end of the second contact part 64B including the free end 64B1 extends in a direction intersecting (for example, perpendicular to) the extension axis of the signal terminal 61 of the counterpart terminal unit 60B (the axis extending in the longitudinal direction of the signal terminal 61). As depicted in FIG. 7B and other figures, the second curved part 64B2 is a portion curved to bulge out obliquely downward toward the front (X-axis positive direction). As described above, since the contact part 64 is curved so as to have a generally S-shape in a side view, the tip end of the second contact part 64B including the free end 64B1 is located forward of the main body part 63. In other words, the main body part 63 is located slightly toward the rear of the terminal unit 60, whereas the tip end of the second contact part 64B including the free end 64B1 is located slightly toward the front of the terminal unit 60.

In addition, the first contact part 64A includes a linear part 64A1 located at the lower end thereof adjacent to the main body part 63, and a gently curved first curved part 64A2. The linear part 64A1 is a portion that comes into contact with the free end 64B1 of the signal terminal 61 of the counterpart terminal unit 60B when the terminal unit 60A is connected to the counterpart terminal unit 60B. As depicted in FIG. 7B, the first curved part 64A2 is a portion that bulges out diagonally upward toward the rear (X-axis negative direction), and is the curved part along which the free end 64B1 of the signal terminal 61 of the counterpart terminal unit 60B slides and is guided when the terminal unit 60A is connected to the counterpart terminal unit 60B.

When the tail part 62 is connected by soldering or the like to a terminal connection pad connected to a conductive trace on a board, a solder ball is preferably applied to the lower surface thereof (Z-axis negative direction side surface), and in the example depicted in the figure, the tip is formed in a semicircular shape to accommodate the solder ball. Furthermore, the curved part 62b is preferably formed with a slot 62a, which is a through hole, for preventing solder wicking.

As depicted in FIG. 8B and FIG. 12B, the U-shaped terminal 71A includes a main body part 71A1 having a roughly rectangular plate-shape extending in the vertical direction and the width direction (Y-axis direction), a pair of left and right side plate parts 71A2 extending forward from both ends of the main body part 71A1 in the width direction, and a tail part 72 serving as a board connection part that is connected to the lower ends of the main body part 71A1 and the side plate parts 71A2 via curved parts 72b and extends outward.

An elastically deformable side contact part 74A serving as a second contact part extending upward is integrally connected to the vicinity of the upper end of each side plate part 71A2. When viewed from the side, in other words, in the width direction (Y-axis direction) of the terminal unit 60, the side contact part 74A includes a second elastic deformation part 74A2 that is approximately in the shape of a right-angled triangle, and a band-shaped first elastic deformation part 74A1 that has an approximately constant width dimension and extends upward from the upper end of the second elastic deformation part 74A2. The first elastic deformation part 74A1 is the portion that comes into contact with the side plate part 71A2 of the counterpart terminal unit 60B when the terminal unit 60A is connected to the counterpart terminal unit 60B, and in side view extends upward at a position biased toward the front end of the side plate part 71A2. As a result, when the terminal unit 60A is connected to the counterpart terminal unit 60B, the first elastic deformation part 74A1 can come into contact with a flat portion biased toward the rear end of the side plate part 71A2 of the counterpart terminal unit 60B without interfering with the first elastic deformation part 74A1 of the counterpart terminal unit 60B.

The second elastic deformation part 74A2 is preferably formed with a triangular opening 75A, which is a through hole having a substantially right-angle triangular shape in a side view. Thereby the rigidity of the second elastic deformation part 74A2 is reduced, facilitating elastic deformation of the second elastic deformation part 74A2. In addition, the second elastic deformation part 74A2 is formed with an offset curved part 74A3 that offsets the first elastic deformation part 74A1 outward in the width direction from the side plate part 71A2 by a dimension that is approximately equivalent to the plate thickness of the side plate part 71A2. The offset curved part 74A3 is a curved portion that is roughly crank-shaped when viewed from the front-to-back direction (X-axis direction), which allows the inner surface of the first elastic deformation part 74A1 to smoothly contact the outer surface of the side plate part 71A2 of the counterpart terminal unit 60B when the terminal unit 60A is connected to the counterpart terminal unit 60B.

The first elastic deformation part 74A1 includes a free end 74A1a located at the tip end thereof, and a gently curved outward curved part 74A1b located below the free end 74A1a. As depicted in FIG. 8B, the outward curved part 74A1b is a curved portion that bulges outward diagonally upward in the width direction of the U-shaped terminal 71A, so that the free end 74A1a faces diagonally upward outward in the width direction of the U-shaped terminal 71A, and the area near the free end 74A1a becomes a turn, in other words, an inclined surface, for smoothly guiding the outer surface of the side plate part 71A2 of the counterpart terminal unit 60B along the inner surface of the first elastic deformation part 74A1 when the terminal unit 60A is connected to the counterpart terminal unit 60B.

When the tail part 72 of the U-shaped terminal 71A is connected by soldering or the like to a terminal connection pad connected to a conductive trace on a board, a solder ball is preferably applied to the lower surface thereof (Z-axis negative direction side surface), and in the example depicted in the figure, the pad is formed into a roughly circular shape to accommodate the solder ball. Furthermore, in order to prevent solder wicking, a curved part 72b is preferably formed to be narrower than a tail part 72, that is, to have a narrower neck. Note that in the example depicted in the figure, two tail parts 72 each are connected to the lower end of the main body part 71A1 and to the lower end of each side plate part 71A2, but the number and arrangement of the tail parts 72 can be changed as needed.

As depicted in FIG. 7A and FIG. 11A, the tab-shaped terminal 71B includes a main body part 73B having a generally rectangular plate-shape extending in the vertical direction and the width direction (Y-axis direction), a tail part 72 connected to the lower end of the main body part 73B via a curved part 72b and serving as a board connection part extending forward (X-axis positive direction), and a contact part 74B connected to the upper end of the main body part 73B and serving as a third contact part.

The contact part 74B is a member that resembles a band-shaped member with a nearly constant width extending in the vertical direction, to the tip of which is connected a trapezoidal plate material with a gradually decreasing width, but when viewed from the side, in other words, in the width direction (Y-axis direction) of the terminal unit 60, the contact part is an elastically deformable member that is curved so as to form an approximately S-shape. Note that since the main body part 73B extends downward (Z-axis negative direction) from the lower end of the contact part 74B, the tab-shaped terminal 71B can also be said to be generally S-shaped as a whole in the side surface view.

Furthermore, a rectangular opening 75B, which is a through hole having a substantially rectangular shape, is preferably formed in the contact part 74B. This reduces the rigidity of the contact part 74B, making the contact part 74B more susceptible to elastic deformation.

The contact part 74B includes a third curved part 74B3 located below, a first curved part 74B1 located above (Z-axis positive direction), and an intermediate curved part 74B2 located midway between the third curved part 74B3 and the first curved part 74B1.

In addition, the contact part 74B includes a free end 74B1a located at the tip end thereof and a gently curved outwardly curved part 74B1b located below the free end 74B1a. As depicted in FIG. 6, and the like, the outwardly curved part 74B1b is a curved portion that bulges outward diagonally upward toward the front of the U-shaped terminal 71A, so that the free end 74B1a faces diagonally upward toward the outside of the front of the U-shaped terminal 71A, and the area near the free end 74B1a forms a turn, in other words, an inclined surface, for smoothly guiding the outer surface of the main body part 71A1 of the counterpart terminal unit 60B along the inner surface of the first curved part 74B1 when the terminal unit 60A is connected to the counterpart terminal unit 60B.

When the tail part 72 of the tab-shaped terminal 71B is connected by soldering or the like to a terminal connection pad connected to a conductive trace on a board, a solder ball is preferably applied to the lower surface thereof (Z-axis negative direction side surface), and in the example depicted in the figure, the pad is formed into a roughly circular shape to accommodate the solder ball. Furthermore, in order to prevent solder wicking, a curved part 72b is preferably formed to be narrower than a tail part 72, that is, to have a narrower neck. Note that in the example depicted in the figure, two tail parts 72 are connected to the lower end of the main body part 73B, but the number and arrangement of the tail parts 72 can be changed as needed.

In the example depicted in FIG. 8A and FIG. 12A, the terminal housing 51 includes a generally thick plate-shaped main body part 53 integrally formed from an insulating material having a certain degree of elasticity, such as synthetic resin, a protruding part 53a protruding upward from the upper surface of a main body part 53, a recess part 54, a U-shaped terminal mounting recess part 55A, a tab-shaped terminal mounting recess part 55B, and a rear protruding part 56A. The protruding part 53a is located at the front end of the recess part 54 and, as depicted in FIG. 13, abuts against the front surface of the main body part 63 of the signal terminal 61 integrated with the terminal housing 51, preventing the main body part 63 from tilting forward when the second contact part 64B receives a forward pressing force from the signal terminal 61 of the counterpart terminal unit 60B.

In addition, the terminal housing 51 also includes the rearward protruding part 56A, sideward protruding part 56B, and forward protruding part 56C as crush ribs that protrude outward near the lower end of the terminal unit 60. As depicted in the figure, the rear protruding part 56A protrudes rearward from the outer surface of the main body part 71A1 of the U-shaped terminal 71A, the sideward protruding part 56B protrudes widthwise outward from the outer surface of the side plate part 71A2 of the U-shaped terminal 71A, and the forward protruding part 56C protrudes forward from the front end of the side plate part 71A2 of the U-shaped terminal 71A. As a result, when the terminal unit 60 is stowed in the terminal unit stowing cavity 15 formed in the connector housing 11, the vicinity of the lower end of the terminal unit 60 is stowed in the terminal unit retention opening 15c formed near the lower end of the terminal unit stowing cavity 15, and the rear protruding part 56A, sideward protruding part 56B and forward protruding part 56C that protrude outward near the lower end of the terminal unit 60 abut against the inner wall surface of the terminal unit retention opening 15c, thereby retaining the terminal unit 60. In other words, the rear protruding part 56A, the sideward protruding part 56B and the forward protruding part 56C of the terminal housing 51 are retained in contact with the inner wall surface of the terminal unit retention opening 15c, so that the terminal unit 60 is stowed and retained within the terminal unit stowing cavity 15 with the shield terminal 71 and the signal terminal 61 not in contact with the connector housing 11.

In this manner, the terminal unit 60 is retained in place by the rear protruding part 56A, the sideward protruding part 56B, and the forward protruding part 56C, which act as elastic crush ribs that protrude outward, abutting against the connector housing 11, and the shield terminal 71 does not come into contact with the connector housing 11. Therefore, since no external force is transmitted from the connector housing 11 to the shield terminal 71, the shield terminal 71 does not deform, the distance between the signal terminal 61 and the shield terminal 71 is maintained constant, resonance does not occur between the signal terminal 61 and the shield terminal 71, and the SI characteristics of the high-frequency signal transmitted by the signal terminal 61 do not deteriorate.

Note that as depicted in FIGS. 2 and 5, in the connector 10, the terminal units 60 located on both sides of each protruding ridge part 13 face each other. In other words, the orientation of the terminal units 60 is to face each other, facing forward (X-axis positive direction). More specifically, the terminal unit 60 stowed in the terminal unit stowing cavity 15 formed on the right-side wall of one of the protruding ridge parts 13 and the terminal unit 60 stowed in the terminal unit stowing cavity 15 formed on the left-side wall are oriented so that the side with the tab-shaped terminal 71B faces the protruding ridge parts 13.

As depicted in FIGS. 6, 10, and 14 to 17, in the terminal unit 60 of the present embodiment, the shield terminal 71, which includes a U-shaped terminal 71A and a tab-shaped terminal 71B, has a roughly rectangular tube shape and surrounds the signal terminal 61. Specifically, the shield terminal 71 covers most of the four sides of the signal terminal 61 from the lower end to the upper end of the signal terminal 61. Therefore, the shield terminal 71 exhibits effective electromagnetic shielding performance, the signal terminal 61 is reliably shielded, crosstalk does not occur, and the SI characteristics of the high-frequency signal transmitted by the signal terminal 61 do not deteriorate.

As depicted in FIGS. 17A-B, the tail part 62 of the signal terminal 61 is located approximately in the center of the area surrounded by the numerous tail parts 72 of the shield terminal 71, and while the signal terminal 61 is roughly S-shaped in side view, the tab-shaped terminal 71B is also roughly S-shaped in side view, so the distance between the signal terminal 61 and the surrounding shield terminal 71 does not change significantly over the range from the bottom end to the upper end of the signal terminal 61. Therefore, the terminal unit 60 can be said to have a configuration similar to a coaxial cable in which the signal wire located in the center is covered with a shield member, in other words, a pseudo-coaxial cable configuration, so that crosstalk does not occur and the SI characteristics of the high-frequency signal transmitted by the signal terminal 61 do not deteriorate.

Next, the operation of mating the connector 10A with the counterpart connector 10B will be described.

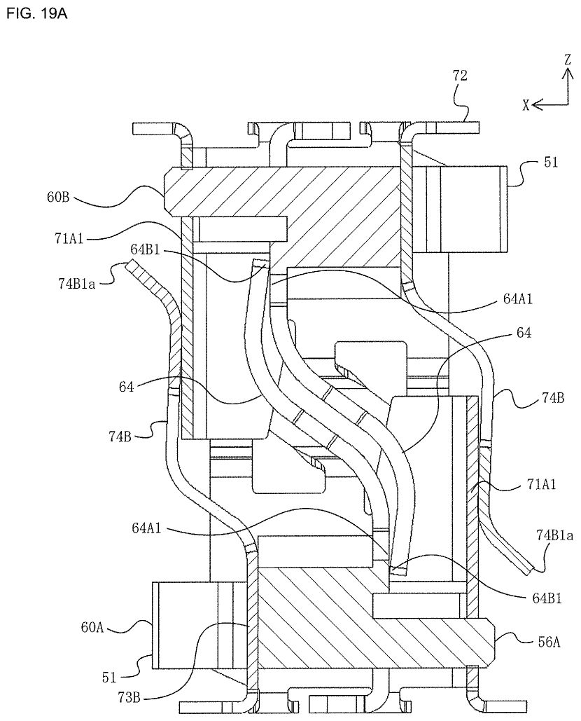

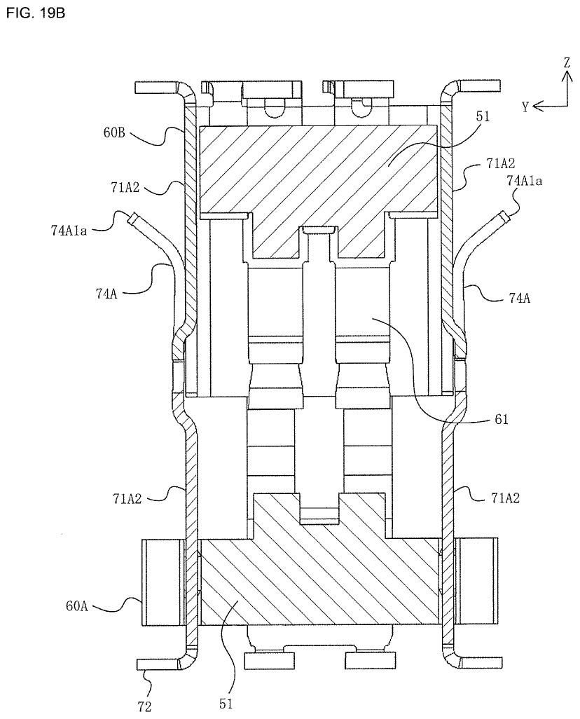

FIGS. 18A-C are a three-view drawing depicting a state in which terminal units according to Embodiment 1 are connected to each other. FIGS. 19A-B are a cross-sectional view depicting a state in which terminal units according to Embodiment 1 are connected to each other. Note that FIG. 18A is a plan view, FIG. 18B is a right-side view, and FIG. 18C is a rear view, and in FIG. 19A is a cross-sectional view along line D-D in FIG. 18A, and FIG. 19B is a cross-sectional view along line E-E in FIG. 18A.

Here, it is assumed that the connector 10A is surface-mounted on a board (not depicted). Specifically, with the mounting surface 11d of the connector housing 11 facing the surface of the board and the housing legs 16c of the connector housing 11 abutting the surface of the board, the tail part 62 of the signal terminal 61 and the tail part 72 of the shield terminal 71 in each terminal unit 60A are connected by soldering to terminal connection pads connected to conductive traces on a board (not depicted). This secures the connector 10A to the board.

In this case, preferably, solder balls are first applied to the lower surface of the tail part 62 of the signal terminal 61 and the lower surface of the tail part 72 of the shield terminal 71, and then soldering is performed by melting the solder balls. In addition, the conductive trace connected to the terminal connection pad to which the tail part 62 of the signal terminal 61 is connected is a signal line that transmits high-frequency signals, and the like, and the conductive trace connected to the terminal connection pad to which the tail part 72 of the shield terminal 71 is connected is a ground line.

Similarly, the counterpart connector 10B is assumed to be surface-mounted on a board (not depicted). Specifically, with the mounting surface 11d of the connector housing 11 facing the surface of the board and the housing legs 16c of the connector housing 11 abutting the surface of the board, the tail part 62 of the signal terminal 61 and the tail part 72 of the shield terminal 71 in each counterpart terminal unit 60B are connected by soldering to terminal connection pads connected to conductive traces on a board (not depicted). As a result, the counterpart connector 10B is secured to the board.

In this case, preferably, solder balls are first applied to the lower surface of the tail part 62 of the signal terminal 61 and the lower surface of the tail part 72 of the shield terminal 71, and then soldering is performed by melting the solder balls. In addition, the conductive trace connected to the terminal connection pad to which the tail part 62 of the signal terminal 61 is connected is a signal line that transmits high-frequency signals, and the like, and the conductive trace connected to the terminal connection pad to which the tail part 72 of the shield terminal 71 is connected is a ground line.

Furthermore, the operator positions the mating surface 11c of the connector housing 11 of connector 10A opposite the mating surface 11c of the connector housing 11 of the counterpart connector 10B, and adjusts the position of the protruding wall part 14d formed on both ends of the short side part 11b at a first longitudinal end of the connector housing 11 of connector 10A so as to match the position of the recess part 12 near the short side part 11b at a first longitudinal end of the connector housing 11 of the counterpart connector 10B, so that the position of the recess part 12 near the short side part 11b at the second longitudinal end of the connector housing 11 of connector 10A matches the position of the protruding wall part 14d formed on both ends of the short side part 11b at the second longitudinal end of the connector housing 11 of the counterpart connector 10B. This completes the alignment of the connector 10A and the counterpart connector 10B.

In this state, when connector 10A and/or counterpart connector 10B are moved in the direction approaching the counterpart side, in other words, in the mating direction, the protruding wall part 14d of the connector housing 11 of connector 10A is inserted into the recess part 12 near the short side part 11b at the first longitudinal end of the connector housing 11 of the counterpart connector 10B, and the protruding wall part 14d of the connector housing 11 of the counterpart connector 10B is inserted into the recess part 12 near the short side part 11b at the first longitudinal end of the connector housing 11 of connector 10A. Furthermore, low wall part 14b of connector housing 11 of connector 10A fits into notch part 14c of connector housing 11 of counterpart connector 10B, and low wall part 14b of connector housing 11 of counterpart connector 10B fits into notched part 14c of connector housing 11 of connector 10A.

As a result, when the connector 10A and the counterpart connector 10B are mated as depicted in FIG. 4, each of the plurality of terminal units 60A of the connector 10A and a corresponding one of the plurality of counterpart terminal units 60B of the counterpart connector 10B are mated and connected to each other, resulting in the state depicted in FIGS. 18 and 19.

As depicted in the figure, when the terminal unit 60A and the counterpart terminal unit 60B are fitted together and connected, the shield terminals 71 come into contact with each other and are electrically connected.

Specifically, the inner surface of the first elastic deformation part 74A1 of the side contact part 74A of the U-shaped terminal 71A of the terminal unit 60A slides relatively upward (Z-axis positive direction) along the outer surface of the side plate part 71A2 of the U-shaped terminal 71A of the counterpart terminal unit 60B to make contact, and the inner surface of the first elastic deformation part 74A1 of the side contact part 74A of the U-shaped terminal 71A of the counterpart terminal unit 60B slides relatively downward (Z-axis negative direction) along the outer surface of the side plate part 71A2 of the U-shaped terminal 71A of the terminal unit 60A to make contact.

At this time, the first elastic deformation part 74A1 of the side contact part 74A of the U-shaped terminal 71A extends upward at a position biased toward the front end of the side plate part 71A2, so as to enable smooth sliding along and making contact with the flat outer surface of the portion biased toward the rear end of the side plate part 71A2 of the counterpart U-shaped terminal 71A without interfering with the first elastic deformation part 74A1. Furthermore, the offset curved part 74A3 formed on the second elastic deformation part 74A2 of the side contact part 74A offsets the first elastic deformation part 74A1 from the side plate part 71A2 to the outside in the width direction of the U-shaped terminal 71A, so that the first elastic deformation part 74A1 can smoothly contact the outer surface of the side plate part 71A2 of the counterpart U-shaped terminal 71A. Furthermore, the free end 74A1a of the first elastic deformation part 74A1 faces diagonally upward outward in the width direction of the U-shaped terminal 71A, and the area near the free end 74A1a forms an inclined surface, so that the outer surface of the side plate part 71A2 of the counterpart U-shaped terminal 71A can be smoothly guided. Furthermore, the triangular opening 75A formed in the second elastic deformation part 74A2 of the side contact part 74A facilitates elastic deformation of the second elastic deformation part 74A2, so that the first elastic deformation part 74A1 can smoothly and elastically displace in response to the outer surface of the side plate part 71A2 of the counterpart U-shaped terminal 71A and can reliably maintain contact with the side plate part 71A2 of the counterpart U-shaped terminal 71A.

In addition, the inner surface of the contact part 74B of the tab-shaped terminal 71B of the terminal unit 60A slides relatively upward (Z-axis positive direction) along the outer surface of the main body part 71A1 of the U-shaped terminal 71A of the counterpart terminal unit 60B to make contact, and the inner surface of the contact part 74B of the tab-shaped terminal 71B of the counterpart terminal unit 60B slides relatively downward (Z-axis negative direction) along the outer surface of the main body part 71A1 of the U-shaped terminal 71A of the terminal unit 60A to make contact.

At this time, the contact part 74B of the tab-shaped terminal 71B is curved so as to be roughly S-shaped when viewed in the width direction (Y-axis direction) of the terminal unit 60A, and the first curved part 74B1 of the contact part 74B is positioned offset forward (X-axis positive direction) from the front end of the side contact part 74A of the U-shaped terminal 71A, so that the first curved part 74B1 can smoothly contact the outer surface of the main body part 71A1 of the counterpart U-shaped terminal 71A. Furthermore, the free end 74B1 a of the first curved part 74B1 faces diagonally upward toward the front outside of the U-shaped terminal 71A, and the area near the free end 74B1a forms an inclined surface, so that the outer surface of the main body part 71A1 of the counterpart U-shaped terminal 71A can be smoothly guided. Furthermore, the rectangular opening 75B formed in the contact part 74B facilitates elastic deformation of the contact part 74B to elastically deform, so that the first curved part 74B1 can smoothly and elastically displace conforming to the outer surface of the main body part 71A1 of the counterpart U-shaped terminal 71A, and can reliably maintain contact with the main body part 71A1 of the counterpart U-shaped terminal 71A.

Furthermore, when the terminal unit 60A and the counterpart terminal unit 60B are fitted together and connected, the signal terminals 61 come into contact with each other and become conductive.

Specifically, in the example depicted in FIG. 19A, the free end 64B1 of the second contact part 64B of each signal terminal 61 of the terminal unit 60A slides relatively upward (Z-axis positive direction) along the rear side surface of the first contact part 64A of the corresponding signal terminal 61 in the counterpart terminal unit 60B, in other words, the surface opposite to the direction in which the tail part 62 extends, to make contact, and the free end 64B1 of the second contact part 64B of each signal terminal 61 of the counterpart terminal unit 60B slides relatively downward (Z-axis negative direction) along the rear side surface of the first contact part 64A of the corresponding signal terminal 61 in the terminal unit 60A, in other words, the surface opposite to the direction in which the tail part 62 extends, to make contact.

At this time, the free end 64B1 of the second contact part 64B abuts against the rear side surface of the gently curved first curved part 64A2 of the counterpart first contact part 64A, and then is guided along the rear side surface to slide relatively, until reaching and coming into contact with the rear side surface of the linear part 64A1 extending in the mating direction, in other words, parallel to the mating axis. As a result, the tip end of the second contact part 64B, including the free end 64B1 extending in a direction intersecting the extension axis of the counterpart signal terminal 61, is in line contact with the rear side surface of the counterpart linear part 64A1. Note that as depicted in FIG. 19A, in a side view, the tip end of the second contact part 64B including the free end 64B1 appears to be in point contact with the rear side surface of the counterpart linear part 64A1. Since the conductive member constituting the signal terminal 61 is not present beyond the tip end of the second contact part 64B, in the signal transmission path from the tail part 62 of the signal terminal 61 through the main body part 63, where the free end 64B1 of the second contact part 64B makes line contact with the counterpart first contact part 64A, and then from the main body part 63 of the counterpart signal terminal 61 to the tail part 62, no so-called stub is formed at the contact point between the free end 64B1 of the second contact part 64B and the counterpart first contact part 64A. Therefore, the signal transmission path formed by each signal terminal 61 and the counterpart signal terminal 61 has stable impedance and is suitable for high-speed signal transmission.

Note that as depicted in FIG. 19A, two signal transmission paths passing through two contact parts 64 are formed between the first contact part 64A of a first signal terminal 61 and the first contact part 64A of the counterpart signal terminal 61, but since each transmission path is maintained in a constant state and the impedances of the two transmission paths are matched, this is a state suitable for high-speed signal transmission.

Furthermore, each of the contact parts 64 that constitute the two signal transmission paths is smoothly curved to form a roughly S-shape when viewed from the side, so that the SI characteristics of the signals transmitted through the transmission paths are well maintained.

Furthermore, the first signal terminal 61 and the counterpart signal terminal 61 that are in contact with each other are surrounded by a first shield terminal 71 and a counterpart shield terminal 71 that are in contact with each other. As depicted in FIG. 19A, when viewed from the side, the tab-shaped terminal 71B is also smoothly curved to form a roughly S-shape, and has a shape similar to that of the contact part 64 that constitutes the two signal transmission paths. This suppresses and reduces the change in the distance between the signal transmission path from the main body part 63 of the first signal terminal 61 to the main body part 63 of the counterpart signal terminal 61 and the shield constituted by the tab-shaped terminal 71B and the main body part 71A1 of the counterpart shield terminal 71 with which the tab-shaped terminal 71B comes into contact. Therefore, when the first terminal unit 60 and the counterpart terminal unit 60 are connected to each other, it can be said that a configuration similar to a coaxial cable in which the signal wire located in the center is covered with a shield member, in other words, a pseudo-coaxial cable configuration, is achieved, so that no crosstalk occurs and the SI characteristics of the high-frequency signal transmitted by the signal terminal 61 do not deteriorate.

Furthermore, when the terminal unit 60A and the counterpart terminal unit 60B are connected to each other, as depicted in FIG. 18B and FIG. 18C, the majority of the signal terminal 61 surrounded by the shield terminal 71 cannot be seen when viewed from the side or from the front-to-back direction. Therefore, it can be said that the signal terminal 61 is electromagnetically shielded from the environment outside the terminal unit 60, so crosstalk does not occur and the SI characteristics of the high-frequency signal transmitted by the signal terminal 61 do not deteriorate.

Note that when the terminal unit 60A and the counterpart terminal unit 60B are mated with each other, three types of mating forces are generated.

The first mating force reaches maximum when the first curved part 74B1 of the contact part 74B of the tab-shaped terminal 71B abuts against the main body part 71A1 of the counterpart U-shaped terminal 71A. When the inner surface of the first curved part 74B1 slides along the outer surface of the main body part 71A1 of the counterpart U-shaped terminal 71A, only the frictional force remains, and the first mating force decreases.

Next, the second mating force reaches maximum when the first elastic deformation part 74A1 of the side contact part 74A of the U-shaped terminal 71A abuts against the side plate part 71A2 of the counterpart U-shaped terminal 71A. When the first elastic deformation part 74A1 slides along the outer surface of the side plate part 71A2 of the counterpart U-shaped terminal 71A, only the frictional force remains, and the second mating force decreases.

Finally, the third mating force reaches a maximum when the free end 64B1 of the second contact part 64B of the signal terminal 61 abuts against the first contact part 64A of the counterpart signal terminal 61. When the free end 64B1 slides along the rear side surface of the first contact part 64A of the counterpart signal terminal 61, only the frictional force remains, and the third mating force decreases.

In the present embodiment, the timings at which the first to third mating forces reach their maximums, that is, the timings at which the first to third mating forces reach their peaks, are set to be offset from one another. This reduces the peak value of the force required to mate the terminal unit 60A with the counterpart terminal unit 60B, and reduces the force required to mate the connector 10A with the counterpart connector 10B.

Furthermore, as depicted in FIGS. 18 and 19, when the terminal unit 60A and the counterpart terminal unit 60B are mated together, the side contact parts 74A of the U-shaped terminal 71A are a pair on the left and right and are designed to sandwich the side plate part 71A2 of the counterpart U-shaped terminal 71A from both sides in the width direction (Y-axis direction), so that no force is applied to either the terminal unit 60A or the counterpart terminal unit 60B that would deflect them in the width direction. In other words, when the terminal unit 60 is mated with the counterpart terminal unit 60, the terminal unit is not subjected to a force component oriented in the width direction (Y-axis direction).

On the other hand, when the terminal unit 60A and the counterpart terminal unit 60B are mated with each other, a force is applied to the contact part 74B of the tab-shaped terminal 71B of the terminal unit 60A so as to deflect the part forward (X-axis positive direction) from the main body part 71A1 of the U-shaped terminal 71A of the counterpart terminal unit 60B, and a force is applied to the main body part 71A1 of the U-shaped terminal 71A of the terminal unit 60A so as to deflect the part forward from the contact part 74B of the tab-shaped terminal 71B of the counterpart terminal unit 60B. Similarly, a force is applied to the free end 64B1 of the second contact part 64B of the signal terminal 61 of the terminal unit 60A so as to deflect the free end forward from the linear part 64A1 of the first contact part 64A of the signal terminal 61 of the counterpart terminal unit 60B, and a force is applied to the linear part 64A1 of the first contact part 64A of the signal terminal 61 of the terminal unit 60A so as to deflect the linear part forward from the free end 64B1 of the second contact part 64B of the signal terminal 61 of the counterpart terminal unit 60B. That is, when the terminal unit 60 is mated with the counterpart terminal unit 60, the terminal unit receives a force component directed forward (X-axis positive direction).

However, when the terminal unit 60 is attached to the connector 10, that is, when the unit is stowed in the terminal unit stowing cavity 15 of the connector housing 11, as described above, the unit is positioned on both sides of each protruding ridge part 13, and each terminal unit 60 faces each other in an orientation facing forward (X-axis positive direction). Therefore, when the connector 10A and the counterpart connector 10B are mated and the terminal unit 60A and the counterpart terminal unit 60B are mated with each other, the forces that the terminal units 60A, which face each other on both sides of each protruding ridge part 13, receive from the counterpart terminal units 60B cancel each other out.

Therefore, when the connector 10A and the counterpart connector 10B are mated, the connector housing 11 in which the terminal unit 60 is stowed, is not subjected to force in the width direction (Y-axis direction) or the longitudinal direction (X-axis direction) through the terminal unit 60. Furthermore, each terminal unit 60 is connected directly to the board, not via the connector housing 11, but by soldering the tail part 62 of the signal terminal 61 and the tail part 72 of the shield terminal 71 to the terminal connection pad, so that the connector housing 11 is not subjected to any force in the height direction (Z-axis direction). As a result, even if the connector 10 has a large number of poles, the connector housing 11 is not subjected to force when the connector 10 is mated with the counterpart connector 10, and is therefore not deformed or damaged.

Note that in the examples depicted in FIGS. 1 to 5, in the protruding ridge part 13 located at the frontmost position (X-axis positive direction), the number of terminal units 60 located in front thereof is less than the number of terminal units 60 located there behind (X-axis negative direction), so strictly speaking, a longitudinal force is generated. However, the total number of terminal units 60 in the example depicted in FIGS. 1 to 5 is 185, and the number of terminal units 60 located in front of the protruding ridge part 13 is only two fewer than the nine terminal units 60 located behind the protruding ridge part 13, so the longitudinal force generated by this is negligible in practical terms. Furthermore, in the example depicted in FIGS. 1 to 5, the seven terminal units 60 lined up in the width direction at the rearmost position (X-axis negative direction) do not have any opposing terminal units 60, so strictly speaking, a longitudinal force is generated. However, as mentioned above, since the total number of terminal units 60 is 185, the longitudinal force generated by the seven terminal units 60 is negligible in practical terms.

Furthermore, as described above, the rear protruding part 56A, the sideward protruding part 56B, and the forward protruding part 56C, which act as elastic crush ribs that protrude outward, abut against and are retained against the connector housing 11, so that the terminal unit 60 does not come into contact with the connector housing 11. Therefore, the force received by the terminal unit 60 is not directly transmitted to the connector housing 11, so that the connector housing 11 does not receive the force when the connector 10 is mated with the counterpart connector 10, and is not deformed or damaged.

In this manner, with the present Embodiment, the first connector 10 is provided with the connector housing 11 and the terminal units 60 retained in the connector housing 11. Furthermore, the terminal unit 60 includes a signal terminal 61, a shield terminal 71 surrounding the signal terminal 61, and a terminal housing 51 to which the signal terminal 61 and the shield terminal 71 are mounted. The terminal housing 51 includes crush ribs 56A, 56B, and 56C protruding outward from the shield terminal 71. The connector housing 11 is formed with a terminal unit stowing cavity 15 in which the terminal unit 60 is stowed, and the terminal unit 60 is stowed and retained in the terminal unit stowing cavity 15 with the shield terminal 71 not in contact with the connector housing 11.

In addition, the terminal unit stowing cavity 15 includes a terminal unit retention opening 15c that penetrates a lower surface 16b of the connector housing 11, and the crush ribs 56A, 56B, and 56C abut against an inner wall surface of the terminal unit retention opening 15c. Furthermore, the signal terminal 61 includes a tail part 62 formed at a lower end thereof, the shield terminal 71 includes a tail part 72 formed at a lower end thereof, and the tail parts 62, 72 of the signal terminal 61 and the shield terminal 71 are exposed on a lower surface 16b of the connector housing 11. Furthermore, the shield terminal 71 includes a U-shaped terminal 71A having a main body part 71A1 and a pair of side plate parts 71A2 extending from both ends of the main body part 71A1, and the crush ribs 56A, 56B, and 56C include a rear protruding part 56A protruding rearward from an outer surface of the main body part 71A1, a sideward protruding part 56B protruding widthwise outward from an outer surface of the side plate parts 71A2, and a forward protruding part 56C protruding forward from a front end of the side plate parts 71A2. Furthermore, there are a plurality of terminal unit stowing cavities 15, arranged so as to form a plurality of pairs of rows extending in a width direction of the connector housing 11, and, in each pair, a terminal unit 60 stowed in a terminal unit stowing cavity 15 forming a first row and a terminal unit 60 stowed in a terminal unit stowing cavity 15 forming a second row face each other.

As a result, the connector 10 can stably maintain a contact state of the signal terminals 61, is suitable for transmitting high-speed signals, can be made multi-polar, can have a simplified structure, can reduce costs, makes mating easy, can be made smaller and thinner, and can improve reliability.

Next, Embodiment 2 will be described. It should be noted that a description is omitted for parts having the same structure as those of Embodiment 1 by assigning the same reference numbers. Moreover, descriptions of the same operations and effects as those of Embodiment 1 will be omitted.

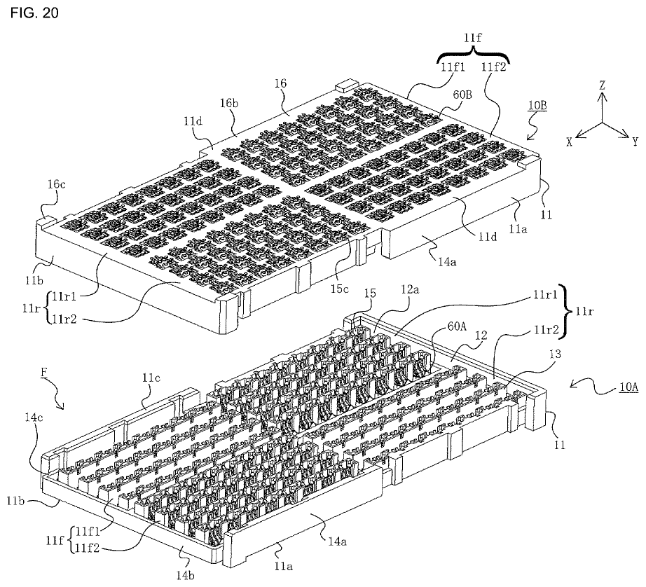

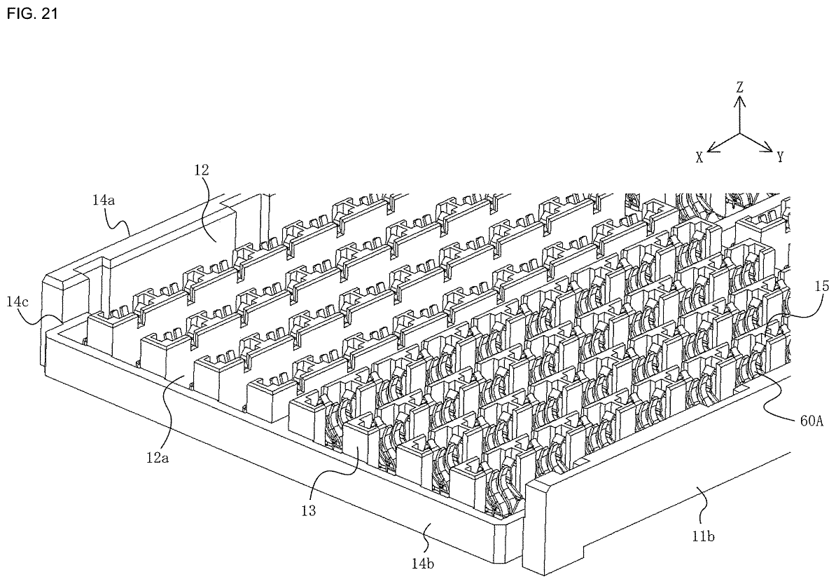

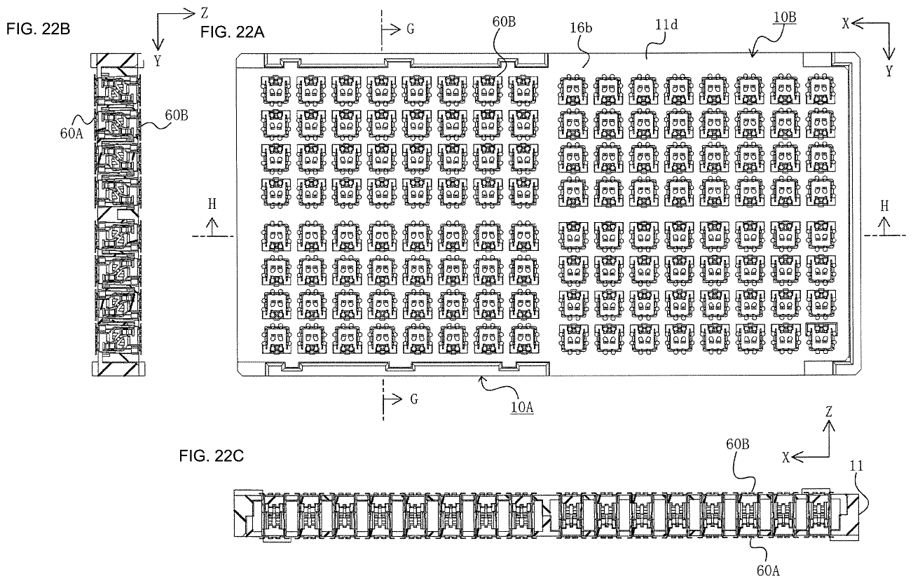

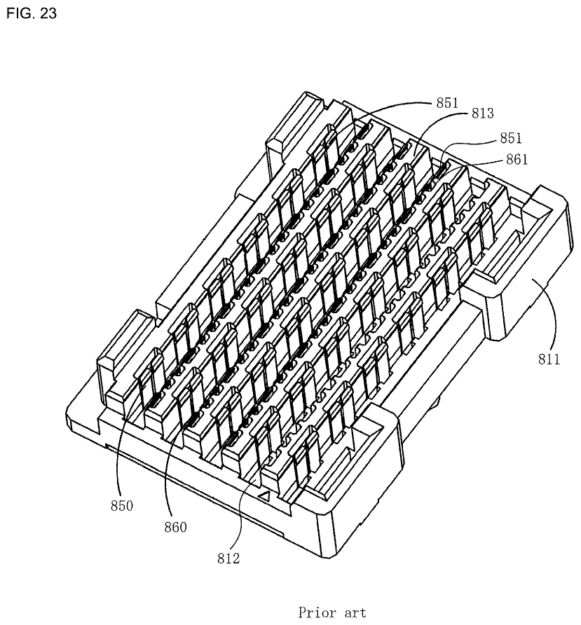

FIG. 20 is a perspective view depicting a state immediately before the connector and the counterpart connector according to Embodiment 2 are mated. FIG. 21 is an enlarged view of a main part of the connector according to Embodiment 2, and is an enlarged view of part F in FIG. 20. FIGS. 22A-C are a three-view drawing of a state in which the connector and counterpart connector according to Embodiment 2 are mated. Note that FIG. 22A is a plan view as viewed from the counterpart connector side, FIG. 22B is a cross-sectional view along the line G-G in FIG. 22A, and FIG. 22C is a cross-sectional view along the line H-H in FIG. 22A.

In Embodiment 1, the protruding ridge part 13 formed in the recess part 12 of the connector housing 11 extends in the width direction (Y-axis direction) of the connector housing 11, whereas in the present embodiment, the protruding ridge part 13 formed in the recess part 12 of the connector housing 11 extends in the longitudinal direction (X-axis direction) of the connector housing 11.

In addition, in Embodiment 1, the terminal unit stowing cavity 15 for stowing the terminal unit 60 is formed on each of the side walls on both sides of each protruding ridge part 13, whereas in the present embodiment, the terminal unit stowing cavity 15 for stowing the terminal unit 60 is formed on only one side wall of each protruding ridge part 13. Therefore, in Embodiment 1, when the terminal units 60 are attached to the connector 10, in other words, when the terminal units are stowed in the terminal unit stowing cavities 15 of the connector housing 11, the terminal units 60 face each other in an orientation facing forward (X-axis positive direction), whereas in the present embodiment, when the terminal units 60 are attached to the connector 10, in other words, when the terminal units are stowed in the terminal unit stowing cavities 15 of the connector housing 11, the terminal units 60 do not face each other.

As depicted in FIG. 20, the connector housing 11 in the present embodiment is divided into four sections in terms of the orientation of the terminal units 60. Specifically, the connector housing is divided into a right front section 11f1 located on the right side (Y-axis positive direction side) of the longitudinal front side (X-axis positive direction side) of the connector housing 11, a left front section 11f2 located on the left side (Y-axis positive direction side) of the longitudinal front side (X-axis positive direction) of the connector housing 11, a right rear section 11r1 located on the right side (Y-axis negative direction side) of the longitudinal rear side (X-axis negative direction side) of the connector housing 11, and a left rear section 11r2 located on the left side (Y-axis positive direction side) of the longitudinal rear side (X-axis negative direction side) of the connector housing 11. Note that when the right front section 11f1 and the left front section 11f2 are described collectively, they will be referred to as the front section 11f, and when the right rear section 11r1 and the left rear section 11r2 are described collectively, they will be referred to as the rear section 11r.

Furthermore, the number of terminal units 60, in other words, the number of poles, included in each of the right front section 11f1, the left front section 11f2, the right rear section 11r1 and the left rear section 11r2 is the same, and in the example depicted in the figure, each has 32 poles. Therefore, the number of poles of the connector 10 in the present embodiment is 128.

In each of the right front section 11f1, the left front section 11f2, the right rear section 11r1 and the left rear section 11r2, all the terminal units 60 face in the same direction.

Specifically, in the right front section 11f1, all the terminal units 60 face the protruding ridge parts 13 in an orientation facing inward in the width direction (Y-axis direction) of the connector housing 11. Therefore, when the connector 10A and the counterpart connector 10B are mated and the terminal unit 60A and the counterpart terminal unit 60B are mated with each other, all of the terminal units 60 in the right front section 11f1 are subjected to a force from the counterpart terminal unit 60 that is directed outward in the width direction of the connector housing 11, in other words, a force directed to the right (facing Y-axis negative direction).

On the other hand, in the left front section 11f2, all the terminal units 60 face the protruding ridge parts 13 in an orientation facing inward in the width direction of the connector housing 11. Therefore, when the connector 10A and the counterpart connector 10B are mated and the terminal unit 60A and the counterpart terminal unit 60B are mated with each other, all of the terminal units 60 in the left front section 11f2 are subjected to a force from the counterpart terminal unit 60 that is directed outward in the width direction of the connector housing 11, in other words, a force directed to the left (facing Y-axis positive direction).

In this manner, when the connector 10A and the counterpart connector 10B are mated and the terminal unit 60A and the counterpart terminal unit 60B are mated with each other, all of the terminal units 60 in the right front section 11f1 are subjected to a force to the right, and all of the terminal units 60 in the left front section 11f2 are subjected to a force to the left, so that for the entire front section 11f, the forces that the terminal units 60 receive from the counterpart terminal units 60 cancel each other out.

In the right rear section 11r1, all the terminal units 60 face the protruding ridge parts 13 in an orientation facing outward in the width direction of the connector housing 11. Therefore, when the connector 10A and the counterpart connector 10B are mated and the terminal unit 60A and the counterpart terminal unit 60B are mated with each other, all of the terminal units 60 in the right rear section 11r1 are subjected to a force from the counterpart terminal unit 60 that is directed inward in the width direction of the connector housing 11, in other words, a force to the left.

On the other hand, in the left rear section 11r2, all the terminal units 60 face the protruding ridge parts 13 in an orientation facing outward in the width direction of the connector housing 11. Therefore, when the connector 10A and the counterpart connector 10B are mated and the terminal unit 60A and the counterpart terminal unit 60B are mated with each other, all of the terminal units 60 in the left rear section 11r2 are subjected to a force from the counterpart terminal unit 60 that is directed inward in the width direction of the connector housing 11, in other words, a force to the right.

In this manner, when the connector 10A and the counterpart connector 10B are mated and the terminal unit 60A and the counterpart terminal unit 60B are mated with each other, all of the terminal units 60 in the right rear section 11r1 are subjected to a force to the left, and all of the terminal units 60 in the left rear section 11r2 are subjected to a force to the right, so that for the entire rear section 11r, the forces that the terminal units 60 receive from the counterpart terminal units 60 cancel each other out.

Note that as in Embodiment 1, when the terminal unit 60 is mated with the counterpart terminal unit 60, the terminal unit 60 is not subjected to any force components directed in the width direction of the terminal unit, and therefore is not subjected to any force in the longitudinal direction of the connector housing 11.

In this manner, with the present Embodiment, a plurality of terminal unit stowing cavities 15 are provided, and arranged so as to form a plurality of rows extending in a longitudinal direction of the connector housing 11, and terminal units 60 stowed in terminal unit stowing cavities 15 located on opposite sides from a widthwise center of the connector housing 11 face in opposite directions to each other.

Therefore, in the present embodiment, when the connector 10A and the counterpart connector 10B are mated, the connector housing 11 that stows the terminal unit 60 is not subjected to any force in the width direction (Y-axis direction) or the longitudinal direction (X-axis direction) via the terminal unit 60. Furthermore, as in Embodiment 1, each terminal unit 60 is connected directly to the board and not via the connector housing 11, so the connector housing 11 is not subjected to forces in the height direction (Z-axis direction). As a result, even if the connector 10 has a large number of poles, the connector housing 11 is not subjected to force when the connector 10 is mated with the counterpart connector 10, and is therefore not deformed or damaged.

Note that the basic configurations of other points of the first connector 10 in the present embodiment are the same as that of Embodiment 1 described above, and therefore, a description thereof is omitted. In addition, the operation of mating the connector 10A with the counterpart connector 10B in the present embodiment, and the basic configuration and effects of other aspects when the connector 10A and the counterpart connector 10B are mated, are the same as those of Embodiment 1, so the explanation thereof will be omitted.

Moreover, the specification disclosure herein describes features relating to suitable typical embodiments. Various other embodiments, modifications, and variations within the scope and spirit of the patent claims appended hereto will naturally be conceived of by a person of ordinary skill in the art upon review of the specification herein.

The present disclosure can be applied to a connector and a connector pair.

1. A connector, comprising:
(a) a housing; and a terminal unit retained in the housing; wherein
(b) the terminal unit includes a signal terminal, a shield terminal surrounding the signal terminal, and a terminal housing to which the signal terminal and the shield terminal are mounted,
(c) the terminal housing includes a crush rib protruding outward from the shield terminal, and
(d) the housing is formed with a terminal unit stowing cavity in which the terminal unit is stowed, the terminal unit being stowed and retained in the terminal unit stowing cavity with the shield terminal not in contact with the housing.

2. The connector according to claim 1, wherein the terminal unit stowing cavity includes a terminal unit retention opening penetrating a lower surface of the housing, and the crush rib abuts against an inner wall surface of the terminal unit retention opening.

3. The connector according to claim 2, wherein the signal terminal includes a board connection part formed at a lower end thereof, the shield terminal includes a board connection part formed at a lower end thereof, and the board connection parts of the signal terminal and the shield terminal are exposed on a lower surface of the housing.

4. The connector according to claim 1, wherein the shield terminal includes a U-shaped terminal having a main body part and a pair of side plate parts extending from both ends of the main body part, and the crush rib includes a rear protruding part protruding rearward from an outer surface of the main body part, a sideward protruding part protruding outward in a width direction from an outer surface of the side plate part, and a forward protruding part protruding forward from a front end of the side plate part.

5. The connector according to claim 1, wherein there are a plurality of terminal unit stowing cavities, arranged so as to form a plurality of pairs of rows extending in a width direction of the housing, and, in each pair, a terminal unit stowed in a terminal unit stowing cavity forming a first row and a terminal unit stowed in a terminal unit stowing cavity forming a second row face each other.

6. The connector according to claim 1, wherein a plurality of terminal unit stowing cavities are provided, and are arranged so as to form a plurality of rows extending in a longitudinal direction of the housing, and terminal units stowed in terminal unit stowing cavities located on opposite sides from a widthwise center of the housing face in opposite directions to each other.

7. A connector pair, comprising: the connector according to claim 1, and a counterpart connector that mates with the connector.
